(19) United States
(12) Patent Application Publication
(10) Pub. No.: US 2005/0001865 A1
(43) Pub. Date: Jan. 6, 2005

(54) Method and apparatus for scanning and printing in ink-jet printer

(76) Inventor: Won-suk Choi, Goyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/863,218

(22) Filed: Jun. 9, 2004

(30) Foreign Application Priority Data
Jun. 9, 2003 (JP) 2003-36744

(51) Int. Cl. B41J 29/38

(52) U.S. Cl. 347/14

(57) ABSTRACT

A method and apparatus for scanning and printing in an ink-jet printer. The method for scanning and printing in an ink-jet printer comprises scanning a first image; determining whether a second externally-provided image is to be combined with the first image; and if it is determined that the first image is to be combined with the second image, combining the first image with the second image.

### BACKGROUND OF THE INVENTION

This application claims the benefit under 35 U.S.C. §119(a) of Korean Patent Application No. 2003-36744, filed on Jun. 9, 2003, in the Korean Intellectual Property Office, the entire disclosure of which is incorporated herein by reference.

1. Field of the Invention

The present invention relates to an ink-jet printer. More particularly, the present invention relates to a method and apparatus for scanning and printing in an ink-jet printer.

2. Description of the Related Art

In general, a multifunctional device performs a scanning function, a copying function, and a printing function and can further perform a facsimile function. However, a printer except for the multifunctional device performs only a printing function. When a user wants to compose a simple image on a document to be printed using the printer, a conventional ink-jet printer inputs a scanned image from a personal computer (PC) and combines the input and scanned image with an image to be printed, thereby printing the combined image. Thus, the conventional ink jet printer cannot combine the scanned image with the image to be printed without the need of a host, such as a PC.

Another conventional ink-jet printer for solving the problem provides a charged coupled device (CCD) or a contact image sensor (CIS), scans a simple image using the charged coupled device (CCD) or the contact image sensor (CIS), and combines the scanned image with an image to be printed, thereby printing a combined result. However, this requires the conventional ink-jet printer to include a separate CCD or a CIS, which is costly and large.

### SUMMARY OF THE INVENTION

The present invention provides a method for scanning and printing in an ink-jet printer, by which a first simple image scanned without a host is combined with a second image to be printed and a combination result is printed.

The present invention also provides an apparatus for scanning and printing in an ink-jet printer, by which a first simple image scanned without a host is combined with a second image to be printed and a combined result is printed.

According to an aspect of the present invention, there is provided a method for scanning and printing in an ink-jet printer, the method comprising scanning a first image; determining whether a second externally-provided image is combined with the first image; and if it is determined that the first image is combined with the second image, combining the first image with the second image.

According to another aspect of the present invention, there is provided an apparatus for scanning and printing in an ink-jet printer, the apparatus comprising a scanning unit for scanning a first image; a combination checking unit for checking whether a second externally-provided image is combined with the first image and outputting a checking result as a first control signal; and an image combination unit for combining the first image with the second image in response to the first control signal.

### BRIEF DESCRIPTION OF THE DRAWINGS

The above and other features and advantages of the present invention will become more apparent by describing in detail embodiments thereof with reference to the attached drawings in which:

FIG. 1 is a flowchart illustrating a method for scanning and printing in an ink-jet printer according to an embodiment of the present invention;

FIG. 2 is a block diagram of an apparatus for scanning and printing in an ink-jet printer according to an embodiment of the present invention;

FIG. 3 is a block diagram of a scanning unit shown in FIG. 2, according to an embodiment of the present invention;

FIG. 4 is a circuit diagram of a light-emitting portion and a light-receiving portion shown in FIG. 3, according to an embodiment of the present invention; and

FIG. 5 illustrates the appearance of an ink-jet printer for explaining the appearance of the scanning unit shown in FIG. 2.

Throughout the drawings it should be understood that like reference numerals are used to depict like features and structures.

### DETAILED DESCRIPTION OF THE INVENTION

Hereinafter, a method for scanning and printing in an ink-jet printer according to embodiments of the present invention will be described in detail with reference to the attached drawings.

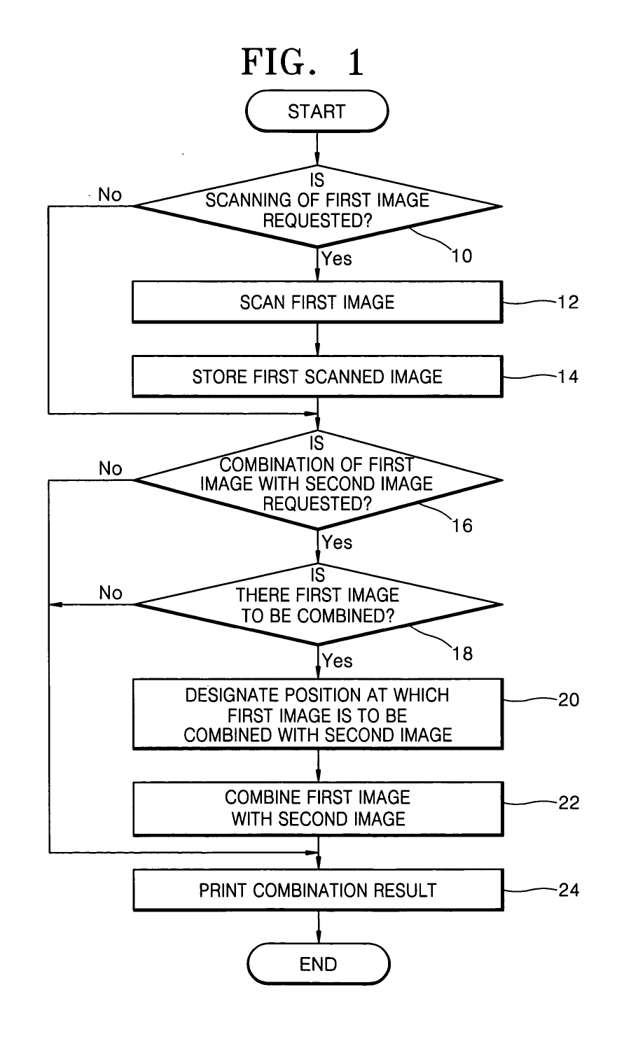

FIG. 1 is a flowchart illustrating a method for scanning and printing in an ink-jet printer according to an embodiment of the present invention. The method for scanning and printing in an ink-jet printer according to an embodiment of the present invention includes scanning and storing a first image (operations 10 through 14), combining the first image with a second image (operations 16 through 22), and printing a combination result (operation 24).

In operation 10, it is determined whether scanning of the first image is requested. Here, the first image corresponds to at least one of a user's signature and a character having a meaning given by the user. Further, the first image may be changed by the user.

If it is determined that scanning of the first image is requested from the user, in operation 12, the first image is scanned. In this case, the first image is scanned two-dimensionally. The first scanned image is stored in step 14.

After operation 14 or if it is determined that scanning of the first image is not requested from the user, in operation 16, it is determined whether it has been requested to combine a second externally-provided image with the first image.

If it is determined that the first image is to be combined with the second image, in operation 18, it is determined whether there is a first image to be combined.

According to an embodiment of the present invention, as shown in FIG. 1, if it is determined that there is a first image to be combined, in operation 20, a position at which the first image is to be combined with the second image is designated. After operation 20, in operation 22, the first image is combined with the second image using the designated position. After operation 22, in operation 24, a combination result is printed. In this case, the first image may be printed at the designated position.

According to another embodiment of the present invention, unlike shown in FIG. 1, the method may omit operation 20. In this case, if it is determined that there is the first image to be combined, in operation 22, the first image is combined with the second image. After operation 22, in operation 24, a combination result is printed. In this case, the first image is combined with the second image at a predetermined position instead of a position designated by the user.

Meanwhile, if it is determined in operation 16 that the first image is not combined with the second image, in operation 24, only the second image is printed. In addition, if it determined in operation 18 that there is no first image to be combined, in operation 24, only the second image is printed.

Hereinafter, the structure and operation of the apparatus for scanning and printing in an ink-jet printer according to an embodiment of the present invention will be described in detail with reference to the attached drawings.

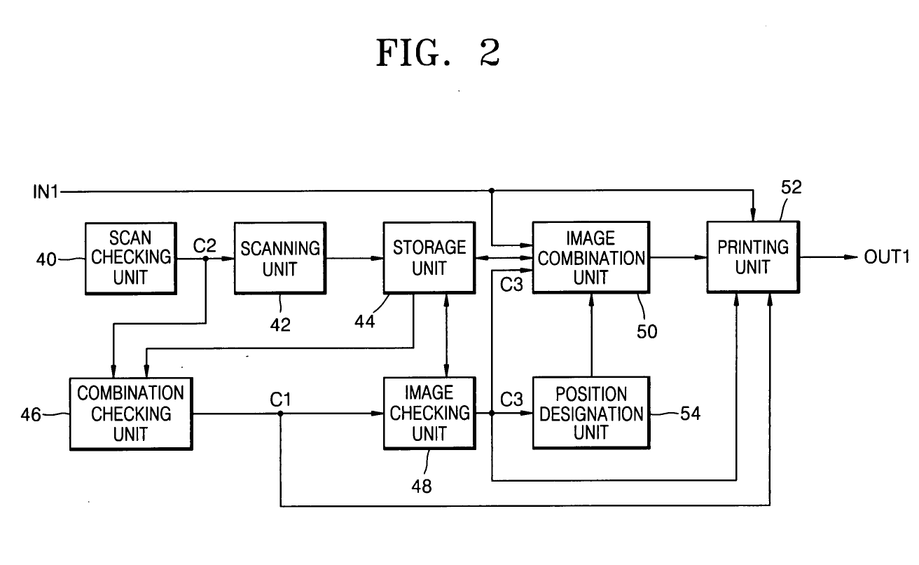

FIG. 2 is a block diagram of an apparatus for scanning and printing in an ink-jet printer according to an embodiment of the present invention. The apparatus for scanning and printing in an ink-jet printer includes a scan checking unit 40, a scanning unit 42, a storage unit 44, a combination checking unit 46, an image checking unit 48, an image combination unit 50, a printing unit 52, and a position designation unit 54.

The apparatus for scanning and printing in an ink-jet printer shown in FIG. 2 is included in the ink-jet printer and may perform the method for scanning and printing in an in-jet printer shown in FIG. 1.

In order to perform operation 10 shown in FIG. 1, the scan checking unit 40 checks whether a user requests scanning of a first image and outputs a checking result as a control signal C2 to the scanning unit 42. To this end, the scan checking unit 40 may be implemented with a key manipulation unit (not shown) for being manipulated by the user who requests scanning of the first image and for generating the control signal C2.

In order to perform operation 12 shown in FIG. 1, the scanning unit 42 scans the first image in response to the control signal C2 input from the scan checking unit 40 and outputs a scanning result to the storage unit 44 (operation 12). For example, if it is recognized from the control signal C2 that the user requests scanning of the first image, the scanning unit 42 scans the first image.

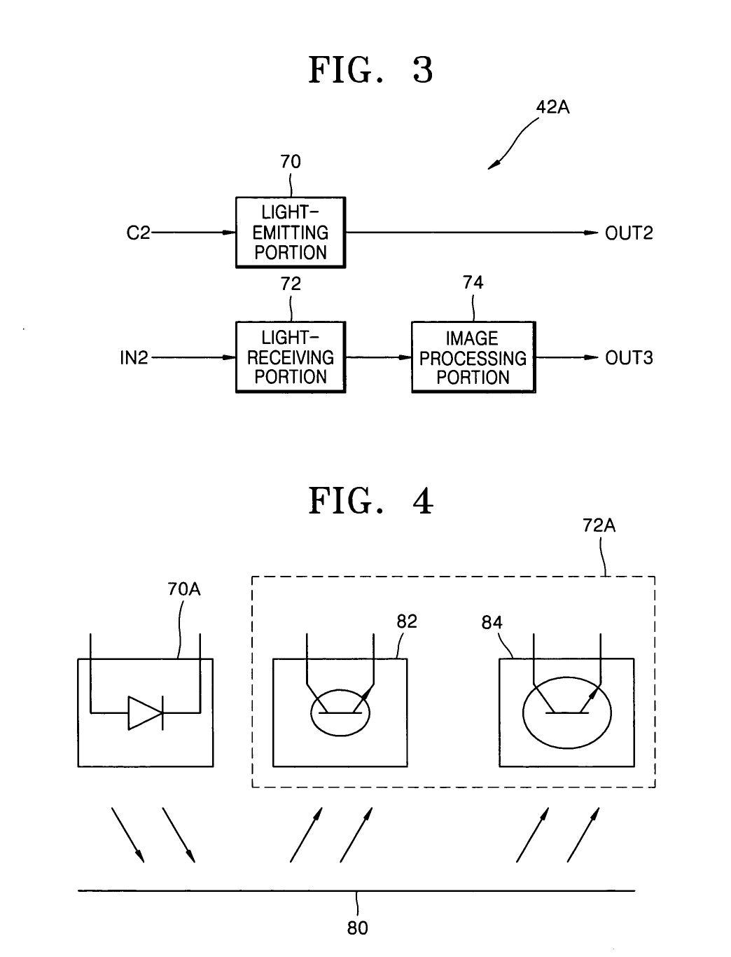

FIG. 3 is a block diagram of the scanning unit 42 shown in FIG. 2, according to an embodiment 42A of the present invention. The scanning unit 42 includes a light-emitting portion 70, a light-receiving portion 72, and an image processing portion 74.

The light-emitting portion 70 of the scanning unit 42A shown in FIG. 3 radiates light onto a document in which a first image is formed, through an output terminal OUT2 in response to the control signal C2 input from the scan checking unit 40. In other words, if it is recognized from the control signal C2 that the user requests scanning of the first image, the light-emitting portion 70 radiates light onto the document.

The light-receiving portion 72 receives light reflected from the document onto which light is irradiated, from an input terminal IN2 and outputs a light-receiving signal having a level corresponding to a light-receiving result to the image processing portion 74. In this case, the image processing portion 74 generates the first scanned image using the light-receiving signal input from the light-receiving portion 72 and outputs the first generated image to the storage unit 44 through an output terminal OUT3. In other words, if the level of the light-receiving signal input from the light-receiving portion 72 is high, the image processing portion 74 recognizes that a sheet of paper is scanned. If the level of the light-receiving signal is low, the image processing portion 74 recognizes that the first image is scanned. This is because the sheet of paper reflects almost all light to increase the amount of light received by the light-receiving portion 72 so that the level of the light-receiving signal is high and the first image reduces the amount of the reflected light to reduce the amount of light received by the light-receiving portion 72 so that the level of the light-receiving signal is low. As such, the image processing portion 74 discriminates the sheet of paper from the first image using a level difference in light-receiving signal, thereby scanning the first image.

FIG. 4 is a circuit diagram of the light-emitting portion 70 and the light-receiving portion 72 shown in FIG. 3, according to an embodiment of the present invention. The embodiment includes a light-emitting portion 70A and a light-receiving portion 72A.

The light-emitting portion 70A shown in FIG. 4 may be implemented with a photo-diode for radiating light onto a document 80 in which the first image is formed, in response to the control signal C2 input from the scan checking unit 40. In addition, the light-receiving portion 72A may be implemented with at least one photo-transistor 82 and 84 for receiving light reflected from the document 80 and generating a light-receiving signal.

Meanwhile, in order to perform operation 14, the storage unit 44 stores the first scanned image input from the scanning unit 42. In this case, at least one first image may be scanned, and the storage unit 44 may be implemented with a nonvolatile memory (not shown) to store at least one first scanned image.

In order to perform operation 16, the combination checking unit 46 checks whether the combination of the first image and the second image is requested by the user, in response to a storage signal input from the storage unit 44 and outputs a checking result as a control signal C1 to the image checking unit 48 and the printing unit 52, respectively. For example, if the combination checking unit 46 recognizes from the storage signal input from the storage unit 44 that the first scanned image is completely stored in the storage unit 44, the combination checking unit 46 checks whether the combination of the first image and the second image is requested by the user. In addition, the combination checking unit 46 may check whether the combination of the first image and the second image is requested by the user, in response to the control signal C2 input from the scan checking unit 40. For example, if it is recognized from the control signal C2 that scanning of the first image is not requested by the user, the combination checking unit 46 checks whether the combination of the first image and the second image is requested by the user. To this end, the combination checking unit 46 may be implemented with a key manipulation unit (not shown) for being manipulated by the user who requests the combination of the first image and the second image and for generating the control signal C1.

In order to perform operation 18, the image checking unit 48 checks whether there is a first image stored in the storage unit 44, in response to the control signal C1 input from the combination checking unit 46 and outputs a checking result as a third control signal C3 to the image combination unit 50, the position designation unit 54, and the printing unit 52, respectively. For example, if it is recognized from the control signal C1 that the combination of the first image and the second image is requested by the user, the image checking unit 48 checks whether there is a first image stored in the storage unit 44.

In order to perform operation 20, the apparatus for scanning and printing in an ink-jet printer shown in FIG. 2 may further include the position designation unit 54. Here, the position designation unit 54 designates a position at which the first image is to be combined with the second image, in response to the third control signal C3 input from the image checking unit 48 and outputs the designated position to the image combination unit 50. For example, if it is recognized from the third control signal C3 that there is a first image to be combined, the position designation unit 54 designates the position at which the first image is to be combined with the second image. In order to perform operation 22, the image combination unit 50 combines the first image read from the storage unit 44 with the second image input through the input terminal IN1 and outputs a combination result to the printing unit 52. Here, the designated position input from the position designation unit 54 is reflected when combining the first image with the second image. In order to perform operation 24, the printing unit 52 prints a combination result input from the image combination unit 50 and outputs a printing result through the output terminal OUT1. In this case, since the designated position is reflected when the image combination unit 50 combines the first image with the second image, when a combination result is printed by the printing unit 52, the first image may be printed at the designated position.

When the method does not include operation 20 shown in FIG. 1, the apparatus for scanning and printing in an ink-jet printer shown in FIG.2 can omit the position designation unit 54. In this case, in order to perform operation 22, the image combination unit 50 combines the first image with the second image in response to the third control signal C3 input from the image checking unit 48. Here, the first image and the second image are combined with each other at a predetermined position instead of the designated position. For example, if it is recognized from the third control signal C3 that there is the first image to be combined, the image combination unit 50 combines the first image with the second image. In order to perform operation 24, the printing unit 52 prints a result combined by the image combination unit 50 and outputs a printing result through the output terminal OUT1. In this case, since the predetermined position instead of the designated position is reflected when the image combination unit 50 combines the first image with the second image, when a combination result is printed by the printing unit 52, the first image may be printed at the predetermined position.

Meanwhile, in order to perform operation 24, the printing unit 52 prints the second image input through the input terminal IN1 in response to the control signal C1 input from the combination checking unit 46 and outputs a printing result through the output terminal OUT1. For example, if it is recognized from the second control signal C2 that the combination of the first image and the second image is not requested by the user, the printing unit 52 prints only the second image input through the input terminal IN1. Further, in order to perform operation 24, the printing unit 52 prints the second image input through the input terminal IN1 in response to the third control signal C3 input from the image checking unit 48 and outputs a printing result through the output terminal OUT1. For example, if it is recognized from the third control signal that there is no first image, the printing unit 52 prints only the second image.

The image combination unit 50 shown in FIG. 2 selectively reads only a first image to be combined from at least one first image stored in the storage unit 44 and receives a second image from an external storage unit (not shown) through the input terminal INI. Here, the external storage unit is a memory which is embedded into a digital camera or a digital camcorder and stores video data taken by the digital camera or the digital camcorder. The memory may be separated from the digital camera or the digital camcorder to be portable or may be mounted on another device, such as a photo-printer for printing photos. For example, the external storage unit can include a memory stick, a secure digital memory card, a multimedia card, an XD-picture card, a compact flash card, a smart media card, or any other suitable memory device.

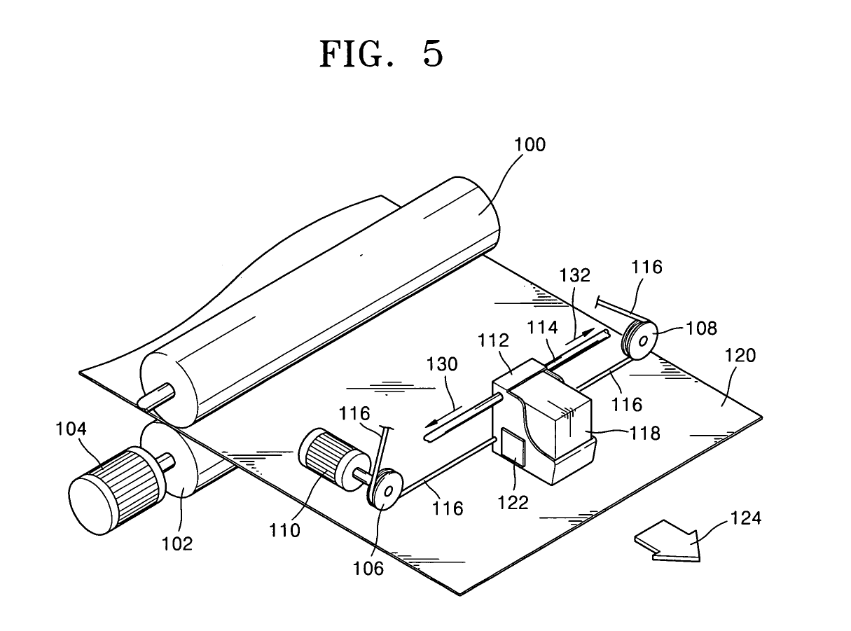

FIG. 5 illustrates the appearance of an ink-jet printer for explaining the appearance of the scanning unit 42 shown in FIG. 2. Referring to FIG. 5, the ink-jet printer includes an upper feed roller 100, a lower feed roller 102, a line feed motor 104, a driving roller 106, an idle roller 108, a carriage motor 110, a carriage 112, a guide bar 114, a belt 116, an ink cartridge 118, a sheet of paper 120, and a scanning unit 122.

Referring to FIG. 5, the lower feed roller 102 rotates while being driven by the line feed motor 104, and the upper feed roller 100 rotates while being engaged with the lower feed roller 102. The sheet of paper 120 inserted between the upper feed roller 100 and the lower feed roller 102 which rotate while being engaged with each other, moves in a direction of arrow 124 as the rollers 100 and 102 driven by the line feed roller 104 rotate.

In this case, the driving roller 106 rotates while being driven by the carriage motor 110. As the driving roller 106 rotates, the belt 116 rotates, and the idle roller 108 rotates. Thus, as the driving roller 106 and the idle roller 108 rotate, the belt 116 rotates counterclockwise or clockwise. In this case, the belt 116 is connected to the carriage 112. Thus, the carriage 112 on which the ink cartridge 118 is mounted moves to the left side 130 or the right side 132 as the belt 116 rotates in a horizontal direction guided by the guide bar 114. Meanwhile, the carriage 112 serves to hold the ink cartridge 118 for ejecting ink and printing a combination result on the sheet of paper 120. In this case, the scanning unit 122 may be provided to the side of the carriage 112. The scanning unit 122 functions as the scanning unit 42 shown in FIG. 2. In other words, the scanning unit 122 includes the light-emitting portion 70 and the light-receiving portion 72 shown in FIG. 3.

As shown in FIG. 5, since the scanning unit 122 is mounted on the side of the carriage 112 transferred by the carriage motor 110, the ink-jet printer having the apparatus for scanning and printing according to an embodiment of the present invention advantageously need not provide an additional motor for moving the scanning unit 42. If the sheet of paper 120 is a document containing a first image, the scanning unit 122 scans the first image contained in the document 120 while moving in the horizontal direction (130 or 132). In this case, the document 120 containing the first image is transferred in the direction of arrow 124 by the line feed motor 104. In other words, since the document 120 containing the first image is transferred by the rollers 100 and 102 driven by the line feed roller 102, the ink-jet printer having the apparatus for scanning and printing according to an embodiment of the present invention need not provide an additional motor for transferring the document 120 containing the first image.

The ink-jet printer having the apparatus for scanning and printing shown in FIG. 2 may be a photo-printer. In this case, the first image, for example, the first image combined with a user's signature, may be printed at a predetermined or a designated position of a photo printed in operation 24.

As described above, in the method and apparatus for scanning and printing in an ink-jet printer according to the present invention, a first image which is generated by a user and can be changed by the user, is scanned without the need of a host and is combined with a second externally-provided image, such that a combination result is printed. In addition, a document containing the first image to be scanned is transferred using a carriage motor and a line feed motor of an ink-jet printer, such that costs for an additional circuit are reduced. Further, the first image can be scanned using low-priced and small sized light-emitting portion and light-receiving portion instead of a high-priced and large sized charged coupled device (CCD) or contact image sensor (CIS).

While this invention has been particularly shown and described with reference to a preferred embodiment thereof, it will be understood by those skilled in the art that various changes in form and details may be made therein without departing from the spirit and scope of the invention as defined by the appended claims and equivalents thereof.

1. A method for scanning and printing in an ink-jet printer, the method comprising the operations of:
scanning a first image;
determining whether a second externally-provided image is to be combined with the first image; and
combining the first image with the second image if it is determined that the first image is to be combined with the second image.

2. The method of claim 1, further comprising storing the first scanned image.

3. The method of claim 2, further comprising:
determining whether the first image is to be scanned, if it is determined that the first image is to be scanned, proceeding to the scanning step, and if it is determined that the first image is not to be scanned, proceeding to the determining step; and
if it is determined that the first image is to be combined with the second image, determining whether there is a first image to be combined, and if it is determined that there is a first image to be combined, proceeding to the combining step.

4. The method of claim 1, further comprising printing a combination result.

5. The method of claim 3, further comprising,
designating a position at which the first image is to be combined with the second image if it is determined that there is a first image and proceeding to the combining step, and
combining the first image with the second image using the designated position.

6. The method of claim 1, wherein the first image corresponds to at least one of a user's signature and a character having a meaning given by the user.

7. The method of claim 1, wherein the first image can be changed by the user.

8. The method of claim 1, wherein in the scanning step, the first image is scanned using a light-emitting portion and a light-receiving portion.

9. An apparatus for scanning and printing in an ink-jet printer, the apparatus comprising:
a scanning unit for scanning a first image;
a combination checking unit for checking whether a second externally-provided image is to be combined with the first image and outputting a checking result as a first control signal; and
an image combination unit for combining the first image with the second image in response to the first control signal.

10. The apparatus of claim 9, further comprising a storage unit for storing the first scanned image input from the scanning unit.

11. The apparatus of claim 10, further comprising:
a scan checking unit for checking whether the first image is to be scanned and outputting a checking result as a second control signal; and
an image checking unit for checking whether there is a first image in response to the first control signal and outputting a checking result as a third control signal,
wherein the scanning unit scans the first image in response to the second control signal and the image combination unit combines the first image with the second image in response to the third control signal.

12. The apparatus of claim 9, further comprising a printing unit for printing a combination result.

13. The apparatus of claim 9 further comprising a carriage motor for transferring a carriage, wherein the scanning unit is mounted on the carriage and scans the first image.

14. The apparatus of claim 9 further comprising a line feed motor for transferring a sheet of paper in a direction in which the combination result is printed;
wherein a document which is scanned by the scanning unit and in which the first image is formed is transferred using the line feed motor.

15. The apparatus of claim 9, wherein the scanning unit comprises:
a light-emitting portion for radiating light onto the document in which the first image is formed;
a light-receiving portion for receiving light reflected from the document and outputting a light-receiving signal having a level corresponding to a light-receiving result; and
an image processing portion for generating the first scanned image from the light-receiving signal and outputting the generated image.

16. The apparatus of claim 15, wherein the light-emitting portion comprises a photo-diode which radiates light onto the document in which the first image is formed, and the light-receiving portion comprises at least one photo-transistor which receives light reflected from the document and generates the light-receiving signal.

17. The apparatus of claim 11, further comprising a position designation unit for designating a position at which the first image is to be combined with the second image in response to the third control signal and outputting the designated position to the image combination unit, wherein the designated position is reflected when the image combination unit combines the first image with the second image.

18. The apparatus of claim 9, wherein the second image is provided from a device selected from the group consisting of a memory stick, a secure digital memory card, a multimedia card, an XD picture card, a compact flash card and a smart media card.

19. The apparatus of claim 9, wherein the ink-jet printer is a photo-printer.
